(19) United States
(12) Patent Application Publication
(10) Pub. No.: US 2013/0238933 A1
(43) Pub. Date: Sep. 12, 2013

(54) MULTI-CORE SOC HAVING DEBUGGING FUNCTION

(71) Applicant: Electronics and Telecommunications Research Institute, (US)

(72) Inventor: Kyoung Seon SHIN, Daejeon (KR)

(73) Assignee: Electronics and Telecommunications Research Institute, Daejeon (KR)

(21) Appl. No.: 13/785,609

(22) Filed: Mar. 5, 2013

(30) Foreign Application Priority Data
Mar. 6, 2012 (KR) 10-2012-0023052

(51) Int. Cl. G06F 11/27

(52) U.S. Cl. CPC G06F 11/27
USPC 714/30

(57) ABSTRACT

There present invention relates to a multi-core System On Chip (SoC) having a debugging function. The multi-core SoC having a debugging function includes one or more processors each configured to include an On Core Debug (OCD); a bus matrix configured to connect buses between the one or more processors and one or more peripheral devices; and a debug interface configured to include Processor Debug Interfaces (PDIs) for communicating with the respective OCDs and a Bus Debug Interface (BDI) for communicating with the bus matrix. In accordance with the present invention, the function of a multi-core SoC which has become complicated as compared with the existing singe core SoC may be efficiently verified.

### CROSS-REFERENCES TO RELATED APPLICATIONS

The present application claims priority under 35 U.S.C. 119(a) to Korean Application No. 10-2012-0023052, filed on Mar. 6, 2012, in the Korean Intellectual Property Office, which is incorporated herein by reference in its entirety set forth in full.

### BACKGROUND

Exemplary embodiments of the present invention relate to a to a multi-core System On Chip (SoC) having a debugging function, and more particularly, a multi-core SoC having a debugging function capable of efficiently verifying a more complicated function as compared with the existing singe core SoC.

With the recent development of system semiconductor technology, a processor-embedded SoC is being widely applied to all fields of an embedded system ranging from personal and portable devices to industrial automation devices.

In particular, according to a high performance demand for potable multi-media devices such as smart phones, multi-core processor technology chiefly used in a computer system is also rapidly being applied to an SoC for an embedded system.

FIG. 1 is a block diagram showing the construction of a common debugging system.

Referring to FIG. 1, the common debugging system includes a host system 110, a debugging signal generator 120, a processor SoC 130, high-speed memory 140, and a peripheral device 150.

The host system 110 manages debugging-related commands and debugging information through an interface (e.g., a GUI and command input) with a user and exchanges electrical signals with the debugging signal generator 120 through a communication port.

The debugging signal generator 120 is responsible for a function of converting debugging-related information into an electrical signal between the host system 110 and the processor SoC 130. For example, if a USB port is used as the communication port for the host system 110 and a port for processor SoC debugging is used for a JTAG standard signal, the debugging signal generator 120 may be formed of a USB-to-JTAG signal generator which may be easily available.

The processor SoC 130 (with the purpose of debugging) is connected to a debugging port, through which debugging information is inputted/outputted, and external devices (e.g., the high-speed memory 140 and the peripheral device 150), and it performs debugging functions (e.g., a data load, the execution or stop of a processor, a processor state check, and memory access) generated from the host system 110.

FIG. 2 is a block diagram showing a construction when the processor SoC 130 of FIG. 1 is a singe core SoC.

The singe core SoC basically includes a processor 210 including a core 212 and cache memory 214, a bus 230, a memory controller 240, a high-speed peripheral device 250 (e.g., a video controller), and a low-speed peripheral device 260 (e.g., an Universal Asynchronous Receiver/Transmitter (UART)).

The processor 210 sequentially reads commands stored in external memory and performs a specific operation for each operation cycle. The result of the operation is used to control the peripheral devices according to circumstances.

The cache memory 214 temporarily stores frequently used data in order to reduce the time it takes to read data from external memory and functions to increase the processing performance of the processor 210 to enable the core 212 to fast access thereto.

From a viewpoint of debugging, the core 212 includes On Core Debug (OCD). The processor 210 basically performs debugging functions (e.g., data loading, the execution or stop of the processor, a core state check, and memory access) which are generated from the host system 110.

However, the conventional debugging system has the following problems.

First, debugging functions, such as the stop of the execution of the processor 210 and a core state check, may be performed in the OCD itself, but there is a problem in that the core 212 must perform a separate debugging program in order to perform functions, such as data loading and memory reading/writing for memory and peripheral circuits outside the processor 210 and a peripheral device state check.

That is, if program debugging is performed, the existing target debugging program must be stopped and the additional debugging program must be performed during the debugging period. Accordingly, in an initial SoC design step and a prototype (e.g., a FPGA) verification step in which hardware block verification must be also performed, an increase of the verification time is added owing to an error due to a hardware or software failure in the process of performing the debugging program.

Furthermore, in an embedded system requiring precise control of a peripheral device per cycle, if a core processor operation according to a change of the peripheral device placed at the slave stage of the bus 230 (e.g., a change of a specific register of the peripheral device) is sought to be debugged, there is a problem in that a desired result may not be obtained by a method using the existing OCD.

In particular, in case of an SoC having a multi-core embedded therein, there are problems in that hardware integration verification in an initial development step and the verification time and debugging efforts in an application program development step are further added owing to the complexities of pipeline execution in several steps and parallel program debugging according to a combination of processors having cache memory buffering, a data sync problem according to the sharing of main memory, and the complexity of hardware according to the implementation of a bus matrix between a multi-master (e.g., a core) and a multi-slave (e.g., peripheral devices).

A related prior art includes Korean Patent Publication No. 10-2008-0022181 (Mar. 10, 2008) entitled ‘MECHANISM FOR STORING AND EXTRACTING TRACE INFORMATION USING INTERNAL MEMORY IN MICROCONTROLLERS’.

### SUMMARY

An embodiment of the present invention relates to a multi-core SoC having a debugging function capable of efficiently verifying a more complicated function as compared with the existing singe core SoC.

Another embodiment of the present invention relates to a multi-core SoC having a debugging function, which is capable of providing reliable debugging information even in a program development step by solving the difficulty of a parallel program debugging operation in a multi-core and removing the overhead of a debugging program using only an OCD at the time of memory or peripheral circuit debugging.

In one embodiment, a multi-core SoC having a debugging function includes one or more processors each configured to include an On Core Debug (OCD); a bus matrix configured to connect buses between the one or more processors and one or more peripheral devices; and a debug interface configured to include Processor Debug Interfaces (PDIs) for communicating with the respective OCDs and a Bus Debug Interface (BDI) for communicating with the bus matrix.

In the present invention, each of the peripheral devices includes an On Peripheral Debug (OPD) which is logic for debugging.

In the present invention, the OCD receives a comparison result signal from the OPD and refers to the comparison result signal for the debugging operation of the processor.

In the present invention, the OPD includes a control register and a condition register configured to receive configuration information related to debugging control and configuration information related to a debugging condition respectively, from the processor or the BDI connected to a master port of the bus matrix and a comparator configured to compare the target comparison signal of a peripheral circuit with the configuration information of the condition register based on the configuration information of the control register and to output a comparison result signal.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram showing the construction of a common debugging system;

FIG. 2 is a block diagram showing a construction when a processor SoC of FIG. 1 is a singe core SoC;

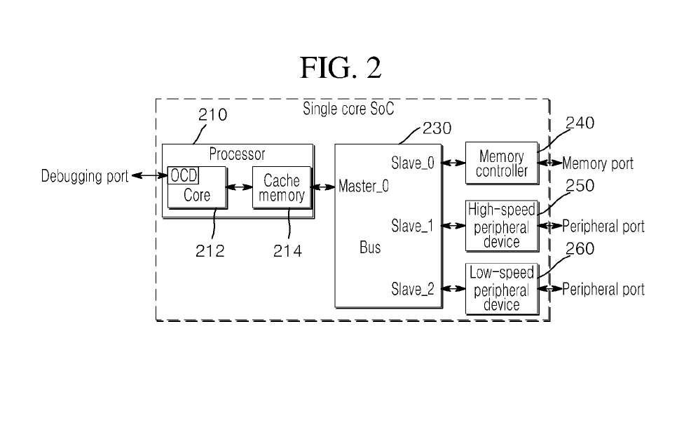

FIG. 3 is a block diagram showing the construction of a multi-core SoC having a debugging function according to an embodiment of the present invention; and

FIG. 4 is a block diagram showing the construction of an OPD in the multi-core SoC having a debugging function according to an embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

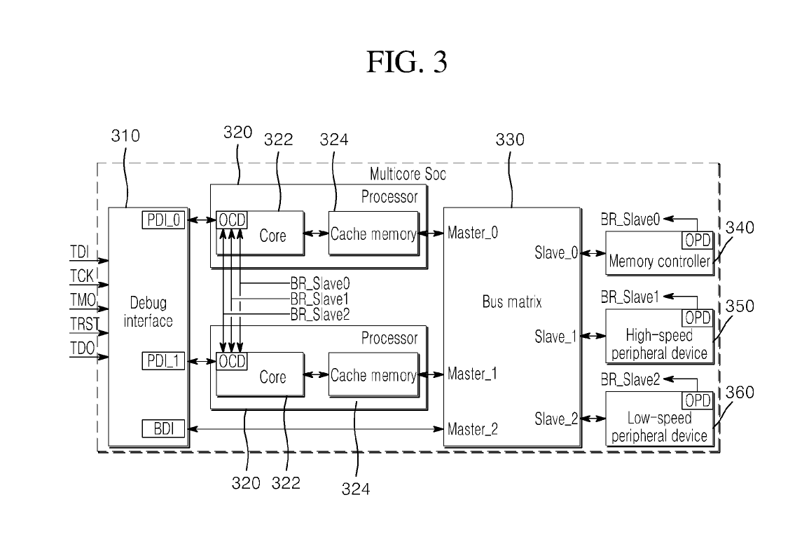

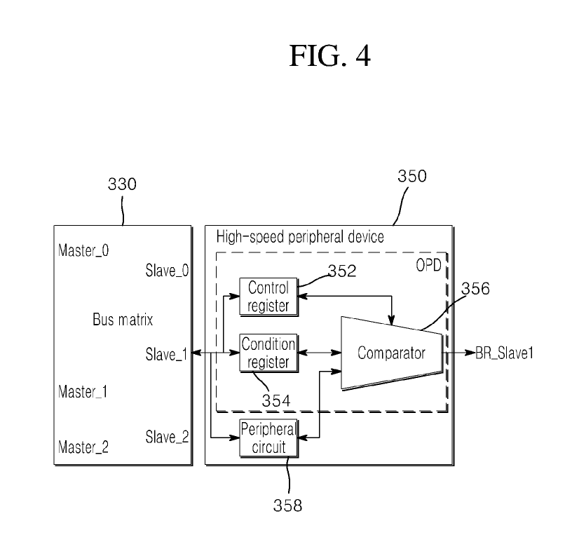

A multi-core SoC having a debugging function according to an embodiment of the present invention is described in detail below with reference to accompanying drawings. FIG. 3 is a block diagram showing the construction of a multi-core SoC having a debugging function according to an embodiment of the present invention, and FIG. 4 is a block diagram showing the construction of an On Peripheral Debug (OPD) in the multi-core SoC having a debugging function according to an embodiment of the present invention.

As shown in FIG. 3, the multi-core SoC having a debugging function according to the embodiment of the present invention may include a debug interface 310 for interfacing with external debug signals, one or more processors 320 for sequentially reading commands stored in external memory and performing predetermined operations on the read commands for each operation cycle, a bus matrix 330 for connecting buses between the one or more processors 320 and a plurality of peripheral devices 340, 350, and 360, a memory controller 340 for accessing data stored in external memory (e.g., a high-speed and high-capacity DDR, flash memory, or SRAM) at the request of the processor 320, and a high-speed peripheral device 350 and a low-speed peripheral device 360 for performing predetermined operations at the request of the processor 320.

The debug interface 310 may include Processor Debug Interfaces (PDIs) connected to the outside through signals according to a common JTAG standard and configured to control the OCDs of the respective processors 320 and a Bus Debug Interface (BDI) directly connected to a master port of the bus matrix 330.

The number of PDIs may be equal to the number of processors 320 embedded in the multi-core SoC and may be implemented to comply with a signal system which may communicate with the OCDs included in the respective processors 320.

For example, the PDI may be implemented according to common memory interface (address, data, and read/write control) signals which may be easily implemented.

Furthermore, the BDI may be implemented to comply with a signal system which may communicate with a master port of the bus matrix 330.

For example, the BDI may be implemented according to Advanced High-performance Bus (AHB) and Advance eXtensible Interface (AXI) standards, that is, common open bus standards.

The bus matrix 330 is configured to enable the processors 320, connected to the master ports, and the BDI to access the peripheral devices 340, 350, and 360 (i.e., the subjects of debugging) through respective slave ports.

Meanwhile, in the multi-core SoC having a debugging function according to the embodiment of the present invention, each of peripheral devices requiring debugging of a cycle unit, such as the memory controller 340, the high-speed peripheral device 350, and the low-speed peripheral device 360, is equipped with an On Peripheral Debug (OPD). The construction of the OPD included in the high-speed peripheral device 350 is shown in FIG. 4 as an example.

The OPD is logic for debugging which is added to a peripheral device requiring debugging according to a change of an operation of a cycle unit. As shown in FIG. 4, the OPD includes a control register 352, a condition register 354, and a comparator 356.

The control register 352 and the condition register 354 receive configuration information from the processor 320 or the BDI connected to a master port of the bus matrix 330.

Here, configuration information related to a debugging control mode may be inputted to the control register 352, and configuration information related to debugging conditions, such as addresses, data, and read/write signals, may be inputted to the condition register 354.

The comparator 352 compares the target comparison signal of a peripheral circuit 358 with the configuration information of the condition register 354 and outputs a comparison result signal BR_Slave to the OCDs of the processors 320.

Next, the OCDs of the processors 320 receive the comparison result signals BR_Slave from the OPDs included in the memory controller 340, the high-speed peripheral device 350, and the low-speed peripheral device 360 respectively, and refer to the comparison result signals BR_Slave when the processors 320 perform debugging operations.

As described above, the multi-core SoC having a debugging function according to the present invention is advantageous in that it is applicable to a common debugging system which may be easily constructed at a low cost when a processor-embedded type SoC is developed.

A debugging program developed in a host system provides an interface with a user, and a user may individually control the processors 320 within the multi-core SoC using the debugging program. In particular, the debugging of parallel programs operated in the respective processors 320 is possible by activating PDI_0 and PDI_1, that is, the PDIs shown in FIG. 3 along with the debugging program.

Furthermore, a user may access all the peripheral devices 340, 350, and 360 (i.e., the subjects of debugging) connected to the respective slave ports of the bus matrix 330 through the BDI in a master capacity.

Accordingly, the present invention may be usefully used for hardware integration verification in an SoC development step. In the program debugging step of the processor 320, if the operations of the peripheral devices 340, 350, and 360 according to the operation of the processor 320 are sought to be debugged, overhead occurring when the processor 320 executes a debugging-dedicated program may be reduced because data related to the operations can be directly gathered through the BDI.

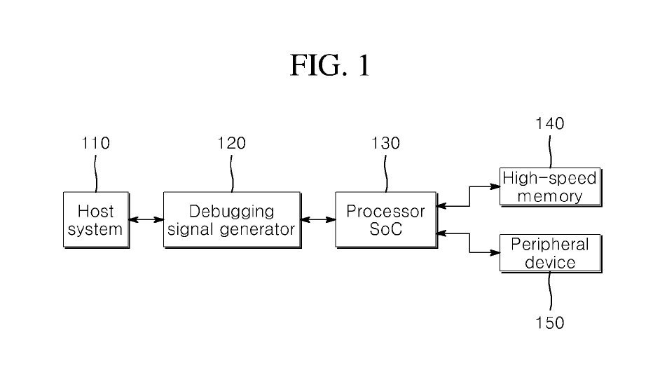

In the program development of an embedded system, program debugging according to a real-time change of the peripheral devices 340, 350, and 360 is frequently necessary. In this case, a user may access the OPDs of the peripheral devices 340, 350, and 360 (i.e., the subjects of debugging) by controlling the BDI using the debugging program of the host system 110 (see FIG. 1) and may set a debugging condition.

The OPD determines a preset condition and an actually executed situation (e.g., when a specific value is written into a specific address of the peripheral circuit 358) and outputs the comparison result signal BR_Slave.

The comparison result signal BR_Slave is inputted to the OCD of the processor 320, thus stopping the operation of the processor 320. Thus, the state of the processor 320 may be checked in real time. That is, the debugging of the processor 320 is possible simultaneously with a change of the peripheral devices 340, 350, and 360.

As described above, in accordance with the multi-core SoC having a debugging function according to the present invention, the multi-core SoC including the plurality of processor cores, memories, and peripheral devices can efficiently verify a more complicated function as compared with the existing singe core SoC.

Furthermore, in accordance with the present invention, the difficulty of debugging of parallel programs operated in a multi-core may be solved, the overhead of a debugging program using the existing OCD when memory or peripheral circuits are debugged may be removed, and the debugging of a processor operation according to a change in the state of a peripheral device in a cycle unit may be possible.

Furthermore, in accordance with the present invention, since the OCDs of respective processors can be controlled, the debugging of parallel programs operated in a multi-core is possible and the debugging of peripheral devices is possible without executing a debugging program in the processors. Accordingly, the overhead of the processor can be removed.

Furthermore, in accordance with the present invention, the debugging of a processor operation according to a change in the state of a peripheral device operating in a cycle unit is possible. Accordingly, there are advantages in that the hardware integration verification time taken for each element in an SoC design step can be reduced and reliable debugging information through various access paths even in a software development step can be provided.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A multi-core System On Chip (SoC) having a debugging function, comprising:
one or more processors each configured to include an On Core Debug (OCD);
a bus matrix configured to connect buses between the one or more processors and one or more peripheral devices; and
a debug interface configured to include Processor Debug Interfaces (PDIs) for communicating with the respective OCDs and a Bus Debug Interface (BDI) for communicating with the bus matrix.

2. The multi-core SoC of claim 1, wherein each of the peripheral devices comprises an On Peripheral Debug (OPD) which is logic for debugging.

3. The multi-core SoC of claim 2, wherein the OCD receives a comparison result signal from the OPD and refers to the comparison result signal for a debugging operation of the processor.

4. The multi-core SoC of claim 2, wherein the OPD comprises:
a control register and a condition register, each configured to receive configuration information related to debugging control and configuration information related to a debugging condition, from the processor or the BDI connected to a master port of the bus matrix; and
a comparator configured to compare a target comparison signal of a peripheral circuit with the configuration information of the condition register based on the configuration information of the control register and output a comparison result signal.
